(19) United States
(12) Patent Application Publication
(10) Pub. No.: US 2024/0126863 A1
(43) Pub. Date: Apr. 18, 2024

(54) PHASED UNENROLLMENT OF DEVICES FROM SERVICE

(71) Applicant: Absolute Software Corporation, Vancouver (CA)

(72) Inventors: Stephen David DUNN, Delta (CA); Marcel Laforce, Delta (CA); Christy May Wyatt, Seattle, WA (US)

(21) Appl. No.: 18/381,478

(22) Filed: Oct. 18, 2023

Related U.S. Application Data
(60) Provisional application No. 63/417,266, filed on Oct. 18, 2022.

(51) Int. Cl. G06F 21/44; G06F 21/10

(52) U.S. Cl. CPC G06F 21/44; G06F 21/1011

(57) ABSTRACT

Fleets of mobile or desktop electronic devices are sometimes wrongly unenrolled from a security and management service. They must then be reenrolled individually, from the devices themselves. To overcome this, a calling agent in each device is only partially removed or disabled upon receipt of the unenrollment instruction. The remaining portion of the calling agent is removed after a cool-off period. During the cool-off period, a persistent component of the calling agent that remains active contacts a monitoring center to check whether there is a cancellation of the unenroll instruction. If there is, the devices can be reenrolled from the monitoring center. This persistent component is designed to survive device reimaging and reinstantiates itself in such an event. This tether provides the ability to reverse unintentional device unenrollment.

### TECHNICAL FIELD

The present disclosure relates to mobile device management, control and security. In particular, it relates to prevention of unwanted unenrollment of devices from a service that provides management, control and security.

### BACKGROUND

Systems such as those provided by Absolute Software Corporation exist for managing fleets of remote devices, allowing them to be tracked and blocked, receive software updates, have data deleted from them and provide surveillance information useful for catching thieves. The devices that are protected or managed have a persistent agent operating on them that regularly calls in to a monitoring center. If the agent is deleted, it can be restored automatically when the device next calls in to the monitoring center. Regeneration of the agent is possible due to a user-inaccessible persistent module embedded in the BIOS of the device. However, with an appropriate communication from the monitoring center to the device, the persistence module can be disabled so that the device stops regenerating the agent and stops calling in to the monitoring center. When this occurs, the device is fully unenrolled, with no chance of it calling the monitoring center, and as such, the monitoring center can no longer communicate with it.

A problem that may occur is that a device can be unintentionally unenrolled, and if it is, the monitoring center is not able to re-enroll it. It is possible that a bug in an application that performs automated unenrollment of devices could accidently attempt to unenroll an entire fleet. The same could occur with a malformed script or SQL commands run directly on the enrolled device database in the monitoring center. The instruction to unenroll a device may be an accident or mistake, it may be an action taken in good faith by someone who has been misinformed, or it may be a malicious action. The problem is magnified in cases where larger fleets of devices are unintentionally unenrolled.

Currently, re-enrolling devices that are mistakenly unenrolled involves manually re-enrolling the devices, one by one, from each device itself.

### SUMMARY

The inventors have realized that a safeguard against unintentional device unenrollment is needed. The solution is to add a cool-off period between the unenroll request and the complete removal of the agent from the device. This creates a time period for detection and correction of accidental and/or unintentional unenrollment requests. Upon receiving the unenroll request, the agent responsible for the connection between the device and the monitoring center is partially disabled. After the end of the cooling-off period, the agent is completely disabled.

### BRIEF DESCRIPTION OF THE DRAWINGS

FIG. 1 is a schematic block diagram of the system showing the context of unenrollment of devices.

FIG. 2 is a flowchart that shows the steps taken by a system to implement the unenroll request with a cool-off period, according to an embodiment of the present invention.

FIG. 3 is a flowchart that shows the steps taken by a system that uses Chromebooks, without the persistence module in BIOS, according to an embodiment of the present invention.

### DETAILED DESCRIPTION

### A. Glossary

Agent. As used herein, an agent is a software, hardware or firmware agent that is persistent and optionally stealthy. Typically, the agent includes or consists of executable instructions that reside in processor readable memory in a computer or other electronic device. The agent typically provides servicing functions which require communication with a remote server. The agent is tamper-resistant and can be enabled for supporting and/or providing various services such as data delete, firewall protection, data encryption, location tracking, message notification, software deployment and updates. An illustrative embodiment of an agent is found in the commercially available product Computrace Agent™. The technology underlying the Computrace Agent™ has been disclosed and patented in the U.S. and other countries, which patents have been commonly assigned to Absolute Software Corporation. See, for example, U.S. Pat. Nos. 5,715,174; 5,764,892; 5,802,280; 6,244,758; 6,269,392; 6,300,863; 6,507,914; 7,818,803; 7,945,709 and related foreign patents. Details of the persistent function of an agent are disclosed in U.S. Patent Application Publications Nos. US2005/0216757 and US2006/0272020. The technical disclosures of these documents are fully incorporated by reference as if fully set forth herein. It is feasible to use an equivalent agent to the Computrace Agent™, or less preferably an alternative agent with less functionality could be used. For the purposes of the present disclosure, the minimum functional attribute of the agent is to facilitate communications between the electronic device and a monitoring center or other remote computer or server. Communications are generally initiated by the agent but may be initiated by the monitoring center in some embodiments.

BIOS—Basic input-output system. As used herein, also includes UEFI which performs the same task in a more modern and secure context.

Device. This is an electronic device to be protected. Examples of a device include a laptop, cell phone, personal digital assistant, smart phone, removable media, personal media device, gaming device, personal computer, tablet computer, electronic book and netbook. The agent resides in the device, which may also be referred to as a host for the agent. A device may also be referred to as a client.

EMS—ESN Management System, used by the Technical Support team to view and modify device and account configuration.

ESN—Electronic serial number, which usually refers to a device in which an agent is installed.

FW—Firmware: Programming instructions that provide control, monitoring and data manipulation for electronic devices. Firmware is typically stored in non-volatile memory components such as ROM (Read-only Memory), EPROM (Electronically programmable ROM), or flash memory in the device. Firmware such as the ROM BIOS of a personal computer may contain only elementary basic functions of the computer and may provide services to higher-level software. Changing the firmware of a device may occasionally be done during its lifetime, for example for updating the firmware, fixing bugs or adding features. Firmware may employ settings that are stored within the firmware or elsewhere in the non-volatile memory in the device. When used herein, the term “firmware” means device firmware such as BIOS, UEFI or similar, unless specifically stated otherwise.

ISV—Independent software vendor

The term “module” can refer to any component in this invention and to any or all of the features of the invention without limitation. A module may be a software, firmware or hardware module that functions by way of a processor executing computer readable instructions stored in software or firmware.

OEM—Original equipment manufacturer

PaaS—Persistence as a Service. Components of a device are maintained and automatically regenerated if corrupted or deleted. Such features may be, for example, the maintenance of a software application on the device.

Persistence—the ability of a module of code to regenerate if it is corrupted or deleted. For example, a persistence module is stored in the FW in an electronic device. The persistence module can contact or generate an agent that causes the device to contact, a monitoring center. During contact with the monitoring center, the agent can be instructed to rebuild missing parts of itself or restore other software components on the device.

Persistence module—the portion of code in a persistent agent that is able to initiate and/or generate calls to a monitoring center despite other portions of the persistent agent being absent or corrupted.

SQL—Structured Query Language, a language for interacting with databases

UEFI—Unified extensible firmware interface

### B. Exemplary Embodiments

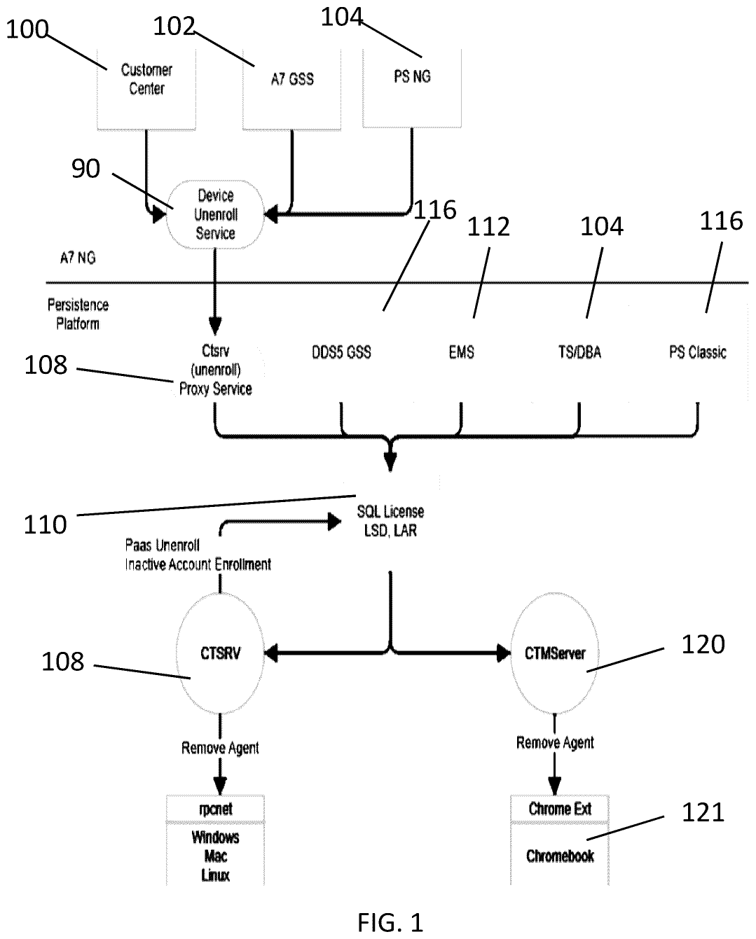

FIG. 1 is schematic block diagram of one embodiment of an example system which can, among other functions, manage the enrollment and unenrollment of devices. In the example of FIG. 1, there are multiple ways in which the enrollment and unenrollment of devices can be managed. In the system shown, there are 3 components that can call the device unenroll service 90, including but not limited to, customer center 100, Google sync services 102 or Professional services 104. The Customer Center 100 is a console into which customers can log in to manage devices. Google sync services (A7 GSS) 102 is used to manage google devices such as Chromebooks. Professional Services (PS NG) 104 can also call the device unenroll service 90.

The device unenroll service 90 performs calls to a proxy service, which for the purposes of this application is called CTSRV 108. CTSRV is a component of the system which handles both persistence and unenrollment of devices. CTSRV 108 is in communication with the SQL License server 110 which documents the current active licenses associated with devices and the corresponding status thereof. While changes to the SQL license server 110 can be made using CTSRV 108, internal management system (EMS) 112, technical support as well as database administrators 114 and other legacy systems 116 can also make changes to the SQL license server 110.

The SQL license server is in communication with CTSRV 108, which when appropriate will unenroll a device. CTSRV 108 completes the unenrollment for Windows, Mac and Linux based devices. For Chromebook devices, a CTMSever 120 is used.

The SQL license server manages the active license associated with devices and tracks the status of each license. Each license can have an Active status (A) where the license is being used by a device, or a deactivated status (D) wherein the license is free to be used with a different device. The SQL license server also includes a time field to set to reflect a predetermined “cool off” period after a request for unenrollment is received.

The main components are:
A) For Windows®, for example: a persistence module 118 in the device, an agent in the device that communicates with a server 108, the server 110, a cool-off time field in the server (not shown), a communications link between the server and the agent.
or
B) For MacOS®, for example: an agent 118 in the device that communicates with a server 108, the server 110, a cool-off time field in the server (not shown), a communications link between the server and the agent.
or
C) For Chromebooks®, for example: a Chromebook® extension 121 a server 120, a cool-off time field in the server (not shown), a communications link between the server and Chromebook®.

One embodiment comprises at least the some of the following elements:
a trigger for unenrollment in the license table in the server;
the server delaying complete agent removal until the end of the cool-off time;
PaaS override for holding account unenroll.

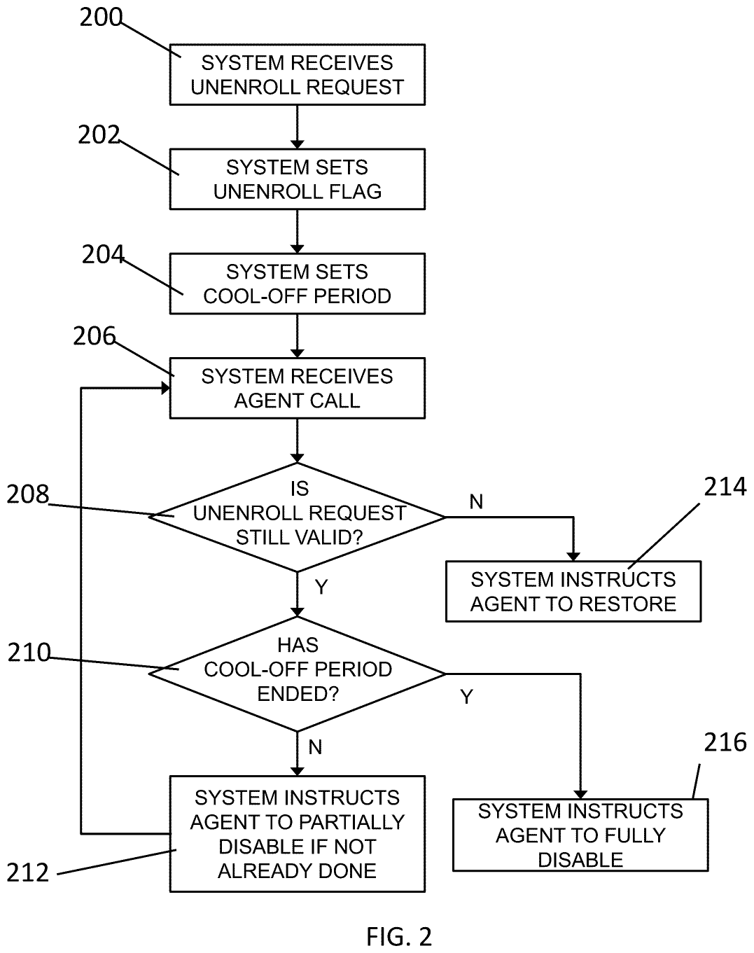

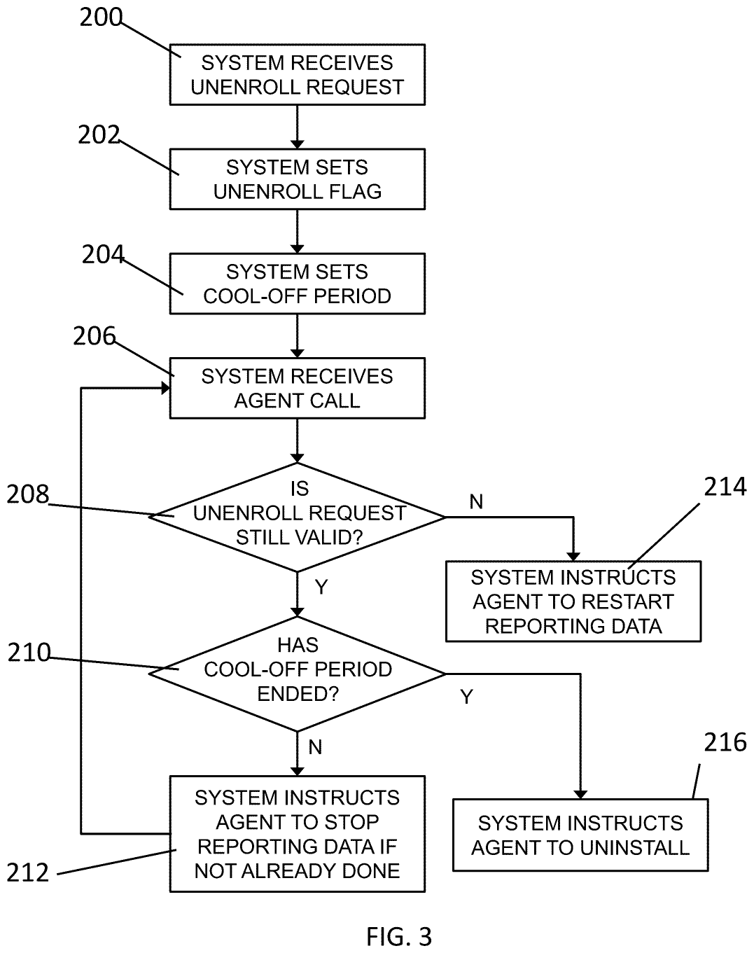

Turning to FIGS. 2 and 3, in the preferred embodiment, the process starts with the system receiving a request to unenroll one or multiple devices 200. It should be noted that FIGS. 2 and 3 are nearly identical, however, FIG. 2 uses the language standard for Windows, Linux or Mac, while FIG. 3 uses the language standard for Chromebooks. This unenrollment request normally is received by the customer center 100, google sync services 102 or the professional services application 104. Through the device unenroll service 90, the SQL license database 110 is updated such that the license of the device requesting unenrollment is set to inactive or “D” (see step 202). A cool-off period is generated at step 204. The cool-off period is implemented by setting a time field in the SQL license database 110 to the end of the cool-off period. In one embodiment, this timestamp may be called “RemovalTimeUTC”, for example. Instead of the server 108 or 120 in the monitoring center (e.g., CTSRV or CTMServer) immediately flagging the agent in the device for removal upon receipt of an unenroll command, the server 108 now delays, ignores or partially fulfills the agent removal instruction for the device if the current time is less than the RemovalTimeUTC. In a preferred embodiment, the timestamp is automatically set to the current time of the instruction plus a cool-off period, by a database trigger which is fired when the corresponding License.Status for the device is updated to ‘D’ by anyone or any subsystem, where “D” is a flag that indicates that the agent is to be disabled for that device. In the case where an application or customer requires immediate agent removal, without the ability to reverse the unenroll command, the RemovalTimeUTC can be set to NULL, for example, as a second update after setting License.Status to ‘D’.

During the cool-off period, the device appears to be unenrolled (status equals ‘D’) from all aspects of the system and has all the agent components removed that obtain and report payloads to the server. As the status is ‘D’ a license will not be consumed during the cool-off period. During this time, the core persistence portion of the agent (i.e., persistence module) remains on the device and maintains a tether to the monitoring center with a callback period that is configured on the server. With reference to FIG. 2, the system receives an agent call 206, checks the SQL license table if the status is still “D” at step 208. If the status is still “D”, the unenroll request is considered to still be valid. The server then checks to see if the cool of period has ended 210. If the cool off period has ended, the server instructs the agent to fully disable. However, if the cool of period has not ended, the system instructs the agent to only partly disable (if not already complete) 212. While a partial disablement of the agent is preferred, it can be appreciated that the agent may not be disabled without departing from the disclosed embodiments. The system then returns to step 206.

Before the cool-off period expires the devices can be reenrolled (i.e., have their unenrollment instructions canceled). This can be done either individually by device or in bulk. To do this, the license table is updated with a new flag or tag. In one embodiment, this can be done by updating their license status to inactive (‘/’ in one embodiment), for example, in the license table. The next time the devices call in 206, they system identifies that they are flagged for re-enrollment and that the unenroll request is no longer valid 210 and their status will be updated to active (e.g., “A”) and the removed agent components will be reinstalled on the devices as per usual operation of the agent 214. This solution is to provide “last resort” protection and is not expected to be a normal or frequent use case. Upon re-enrollment, a license will be consumed by the device.

When setting a cool off period, in the preferred embodiment, in the database 110 in the server 108, a trigger is created in the license table. For example: if status is updated and new status is ‘D’ then set RemovalTimeUTC to current time+72 hours. The duration default can be changed by modifying the trigger. The ability to shorten/modify the removal time or disable it altogether is provided from EMS on a per device or per account level.

In the server 108 (CTSRV) for Windows® devices, for example, when processing a device call immediately after successful partial removal of the agent (i.e., after removal of all components except the persistence module), a check is performed step 210 to determine whether the current time is greater than RemovalTimeUTC. If not, the server stops processing the call. If it is, then processing continues to completely remove the agent 216, by deactivating the persistence module.

During normal running of the agent, the call back time may be set to, e.g., 24.5 hours. During the process of partial or complete agent removal, the call-back time may be 15 mins, for example. After partial agent removal, a value of the order of an hour for the call-back time allows for generally quick recovery when the status field is reset in the monitoring center database. This is the frequency that the persistent module calls the monitoring center to check for re-enrollment instructions.

Chromebooks® and Androids® query the Monitoring Center (CTMServer) to determine if their ESN has been disabled and flagged for removal. If it has been flagged for removal but the cool-off period has not expired, the device will be instructed to stop reporting its normal payload of data but continue to callback for its latest removal status.

To adjust the callback time to a shorter period prior to RemovalTimeUTC passing, it is possible to make an additional change. The callback time is given to the agent as part of EndSession handling, at the end of a call from the persistent module to the server during the cool-off period.

### C. PaaS Devices

Having a 48-72-hour delay for complete agent removal and FW persistence deactivation may be unacceptable for certain applications. An example is PaaS integration with ISVs. This is because, typically, non-Absolute customers have no console access to monitor the state of their devices. Instead, control of enrollment and unenrollment is initiated from the device (rather than a console), with the expectation of uninstalling the PaaS application(s) in a timely window. This includes removing all Absolute software and agents from the device in a timely fashion.

For a PaaS device where the last application is uninstalled and the server triggers unenrollment from a PaaS holding account—the RemovalTimeUTC is updated to NULL after the license status is set to ‘D’.

### Variations

The solution would not be applicable in cases where customer requires a device to be completely clean of Absolute agents/software immediately after requesting unenroll, e.g., PaaS customers as noted above. It would also not be applicable for OEM testing and demo accounts, where complete unenrollment is required under time constraints. In some embodiments of the invention, however, a feature is incorporated to allow an EMS to override the cool-off period on a per-account basis. Another example is device refurbishment/ewaste recycling where immediate unenrollment may be required.

A daily report for monitoring may be provided in some embodiments, so that the devices that are partially unenrolled continue to be reviewed manually.

Overrides of the RemovalTimeUTC via a DBA/SN (Database Administrator, Service Now ticket) may be permitted.

Systems may provide support to adjust cool-off time (up or down) on a per device basis, primarily for testing, but this could be used in special circumstances.

An EMS may provide viewing and editing of the RemovalTimeUTC for a device.

Automated alerts may be generated when unenroll thresholds are met. This would focus on unenroll requests (rather than completions) as the goal is to block an unwanted unenroll before it completes.

Where a processor has been described, it may include two or more constituent processors. Computer readable memories may be divided into multiple constituent memories, of the same or a different type. Steps in the flowcharts and other diagrams may be performed in a different order, steps may be eliminated, or additional steps may be included, without departing from the invention.

The detailed descriptions are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions. In general, unless otherwise indicated, singular elements may be in the plural and vice versa with no loss of generality.

1. An electronic device management system for managing an electronic service comprising
a management server;
at least one electronic device enrolled in the electronic service;
a calling agent installed on the electronic device configured to facilitate calling the management server at predetermined intervals or after predetermined events;
a database containing at least an enrollment status and identity of the at least one electronic device;
wherein when the management server receives a request of unenrollment of the at least one electronic device from the electronic service; the management server accesses the database and changes the status of the device to a disabled status and a predetermined cool-off period is set; once a status of a device has been changed to disabled, the following steps occur:
a. the calling agent of the device continues to call the server according to the predetermined intervals or after the predetermined event;
b. after receiving a call from the device, said management server accesses the database and checks if the status of the device has changed from disabled;
c. if the status is no longer disabled the device is re-enrolled in the electronic service and the process ends; if the status remains disabled, the server determines if the predetermined cool-off period has ended;
d. if the cool off period has ended, the server instruct the calling agent to uninstall and the process ends; if the cool off period has not ended, steps a to d are repeated.

2. An electronic device management system of claim 1 wherein said cool-off period is set automatically after the status is changed to disabled.

3. The electronic device management system according to claim 1 wherein after the status is changed a partial removal of agents associate with the electronic service occurs.

4. A method of managing a plurality of electronic devices configured to be enrolled or unenrolled in a electronic service comprising
a. a management server receiving a request for unenrollment of the at least one of the plurality of electronic devices from the electronic service;
b. the management server accessing a database containing at least an enrollment status and identity of the plurality of electronic devices;
c. changing the status of at least one of the plurality of electronic devices to a disabled status;
d. setting in the database, a predetermined cool-off period;
e. the device continues to calling the server;
f. the management server receiving the call and checking the database to identify the enrollment status of the at least one device of the plurality of devices;
g. if the status is no longer disabled, reenrolling the at least one device of the plurality of devices in the electronic service and the process ends;
h. if the status remains disabled, determining if the predetermined cool-off period has ended;
i. if the cool off period has ended, the server instructing the at least one device of the plurality of devices to uninstall the agent associated with the electronic service and the process ends;
j. if the cool off period has not ended, repeating steps e to j.

5.
